(19) United States
(12) Patent Application Publication
(10) Pub. No.: US 2019/0053467 A1
(43) Pub. Date: Feb. 21, 2019

(54) BOUNCY CAT PET TOY WITH VISUAL ATTRACTANT

(71) Applicant: Matthew James Foley, Tampa, FL (US)

(72) Inventor: Matthew James Foley, Tampa, FL (US)

(21) Appl. No.: 16/133,746

(22) Filed: Sep. 18, 2018

Related U.S. Application Data
(63) Continuation-in-part of application No. 15/285,482, filed on Oct. 5, 2016.
(60) Provisional application No. 62/237,310, filed on Oct. 5, 2015.

(51) Int. Cl. A01K 15/02

(52) U.S. Cl. CPC A01K 15/025; A63B 67/187

(57) ABSTRACT

A pet toy comprises a ball and at least one feather attached to the ball. When used, the pet toy bounces in various directions and its feathers and pet toy movement attract a pet and trigger the pet's hunting instinct. While chasing and capturing the pet toy, the pet is entertained and exercised. The pet toy disclosed has a high coefficient of restitution and is of particular interest to cats.

### CROSS REFERENCE TO RELATED APPLICATION

This nonprovisional utility patent application is a continuation in part of application Ser. No. 15/285,482 pursuant to 35 U.S.C. § 120 which was filed on Oct. 5, 2016. The entire disclosure of that application is hereby incorporated by reference in its entirety.

### BACKGROUND

### 1. Field of Invention

The invention relates generally to the field of pet toys, and more specifically a pet toy for pets, such as cats, which combines a ball with a traditional feather attractant to gain the attention of the pet.

### 2. Related Art

For centuries pet owners have looked for simple toys which can help give pets exercise and entertainment. Dog owners have played fetch with their pets using balls or sticks, and these devices are often acceptable to draw and maintain the attention of a dog. However, not all pets are as easily entertained as dogs. For instance, cat owners face a greater challenge than dog owners when it comes to entertaining their pets. Therefore, pet toys to amuse cats require a greater degree of creativity.

There is a reasonable amount of related art in the field of cat toys. Some examples relate to strings attached to a wand, fake mice, birds, balls within a track and other items. For instance, U.S. Pat. No. 8,944,011 by Kirschbaum discloses an impact action cat toy where the cat owner creates erratic movements of a cat toy play member which is situated at the end of a cord. The cat toy play member can be constructed using a cork and feathers, and the cat owner creates the movement of the toy by moving the rigid tube in a wand like fashion. Similarly, Patent Application No. U.S. 2005/010468 A1 by Fleischhacker discloses a hallow mouse tethered to a fishing reel and rod type assembly. To operate this invention, the cat owner again directs the movements of the hallow mouse by moving and operating the fishing reel and rod to which it is attached.

U.S. Pat. No. 6,032,615 by Girard discloses a ball contained in a track system which appears to simulate a mouse going into a hole. A cat playing with this device can touch the ball, but the ball will always move away from the cat within the confined track. Similarly, U.S. Pat. No. 5,579,725 by Boshears includes a toy animal simulating a mouse contained within a circular housing. Boshears also provides a motorized device where the toy animal is mounted on the outer end of a motor-driven arm. A cat playing with this toy will catch the toy animal momentarily, but the toy animal will begin moving again in a circular pattern through the motor driven arm once released.

The combined usage of a ball with an attractant has also been disclosed. One related combination commercially available includes a rubber ball with a long tail that is approximately eleven (11) inches in length. Another, includes a rubber ball with a cloth tail attached that is approximately seven (7) to eight (8) inches in length. Each of these combinations infuse the tails with a catnip to attract the attention of the cat. Although these combinations have similar elements as the present invention, as shown in the testing performed the design elements achieve much different results and even lead to situations where the attractant interferes and impedes the combinations' movements.

As shown by these particular references and others, current pet toys that are particularly designed for a cat, derive success by triggering the hunting instinct of the cat. In most cases the cat attacks a fake mouse or bird that may be tethered to a wand or other hand held device that is manipulated by a pet owner. In other options, attractants such as balls or fake mice are targets that can be placed in track-like devices so that a cat can touch the targets which will continue to move away from the cat. These type of cat toys have limitations. For tethered devices, pet owners must continuously manipulate the attractant in order to keep the attention of the cat. In track devices, the cat's movements are limited to the vicinity of the device which may not allow for sufficient exercise. For the ball and attractant combinations, the lengthy attractant can get tangled with the ball and reduce its freedom of movement. In the case of the cloth tail, the lack of rigidity of the cloth tail does not provide for a consistent center of gravity for the combination. In many of the cases described here, the devices are not compact and cannot be stored readily in a hand bag or pant pocket. Further, although the devices themselves provide entertainment for the pet, without the pet, they have little entertainment value for the pet owner.

In addition to the various cat toys disclosed, badminton shuttlecocks have some of the same elements as the invention disclosed here. For example, U.S. Pat. No. 2,666,643 by Miller discloses an assembly with a cork that has an aperture to receive the shafts or quills of feathers which are anchored therein. Similarly, U.S. Pat. No. 2,025,325 by Bauer discloses a shuttlecock consisting of a cork with feathers attached at varying depths within the cork.

Although the badminton shuttlecocks disclosed in these patents have some physical similarities to the disclosed invention, the materials used in the design of the shuttlecocks and the feathers or nylon vane attachments, such as those disclosed in U.S. Patent Application Publication no. US2014/0155201 A1 by Yoneyama, serve a much different purpose which is to ensure flight and velocity control when the shuttlecock leaves the badminton racket face. Further, the head or ball of the shuttlecock is typically made of cork or a similar material with a low coefficient of restitution (COR) which is not designed to rebound any great distance or height upon impact with a hard stationary surface. Instead, the shuttlecock is designed to rapidly decelerate following its impact with and departure from the racket face. For this reason, the inherent design of the badminton shuttlecock and its resulting operation cannot capture the interest of a cat due to its stable trajectory when in flight, slower movement, and its standard landing pattern. For this and the aforementioned reasons, there is a need for a pet toy that addresses these limitations with a more dynamic response pattern.

### SUMMARY

Pet owners are in need of a pet toy that is portable, affordable, and that can maintain the interest of a cat. In addition to the above attributes, pet owners seek a pet toy that requires minimal human intervention, triggers the cat's hunting instinct, and will result in exercise for the cat when in use. The exemplary embodiments of the present invention satisfy these needs.

The exemplary embodiments incorporate a traditional solid ball, preferably formed from an elastomeric material with a high modulus of elasticity and a high COR, with two natural feathers extending from the center of the ball. In alternate embodiments, the feathers may extend from a location not at the center of the ball. First, when connected to the ball, the mass of the feathers changes the ball's center of gravity, thereby changing the bouncing behavior of the ball. Second, the feathers provide an attention grabbing visual stimulus to the observing pet. Pet owners can bounce the pet toy against any firm stationary surface (e.g., the floor, walls, etc.) and the feathers create an imbalance causing the pet toy to move erratically until equilibrium is restored. Essentially, each bounce of the pet toy creates a new imbalance, which creates a new erratic movement. This erratic movement of the pet toy is especially attractive for cats, and when combined with the feathers, the movement triggers the cat's hunting instinct. The exemplary embodiments of the present invention have a dual purpose of utility and entertainment and overcome the limitations of the related art.

Regarding utility, the pet owner can use the embodiments to encourage his cat to exercise and remain active. Different cat muscle groups can be focused depending on direction of the pet owner's toss or bounce of the pet toy. For instance, if the pet owner wants his cat to improve its vertical leap, the pet toy can be bounced very hard vertically downward with very little horizontal motion. On the other hand, if the pet owner wants his cat to improve its agility, he may throw the pet toy against a wall and allow it to bounce randomly. To increase the random and sporadic response, a pet owner may impart a spin onto the pet toy on the toss. In addition to the exercise for the pet, the pet toy size also gives it portability which is beneficial when traveling with a pet. Further, because there are no mechanical aspects or moving parts there is no need for batteries and minimal chance of malfunction.

Regarding entertainment, the pet owner can enjoy the embodiments in a self-play mode which would entail bouncing and catching the pet toy without a pet being present. In this usage, the pet toy will have similar characteristics to a yoyo. Further, the pet toy can be tossed, and pet owners can enjoy watching one or more cats chase after and compete to capture the pet toy. Cats can also play with the pet toy by themselves by batting or flinging the pet toy in the air and chasing it for capture.

Exemplary embodiments of the present invention provide an appropriately sized rubber ball with an aperture sized to accommodate one or more quills of feathers of a size proportional to the rubber ball selected. One or more feathers are inserted in the aperture of the ball and fixed in place using an adhesive such as glue or rubber cement.

According to exemplary embodiments of the invention, the pet owner can toss the pet toy in a manner that allows the pet toy to bounce or roll until all energy is dissipated. In the exemplary embodiments presented herein, the pet considered is a cat; however, the pet toy usage and appeal is not limited to cats and can be considered for any domesticated animal. Further, although one or more feathers are identified, other attractants may be equally effective and can be interchanged with the feathers without compromising the spirit of the invention so long as appropriate mass ratios, COR range, and rigidity are maintained.

The construction of the preferred embodiments is completed by creating an aperture within an appropriately sized rubber ball. The aperture should be of a depth and diameter suitable to accommodate one or more appropriately sized feathers so as to allow the feathers to protract outside of the ball. Glue or rubber cement should be added to the aperture to fix the feathers in place.

### BRIEF DESCRIPTION OF THE DRAWINGS

FIG. 1 is a perspective view of the pet toy;

FIG. 2 is a view illustrating the formation of the pet toy; and

FIG. 3 illustrates the pet toy in use following a pet owner toss.

### DESCRIPTION OF EXEMPLARY EMBODIMENTS

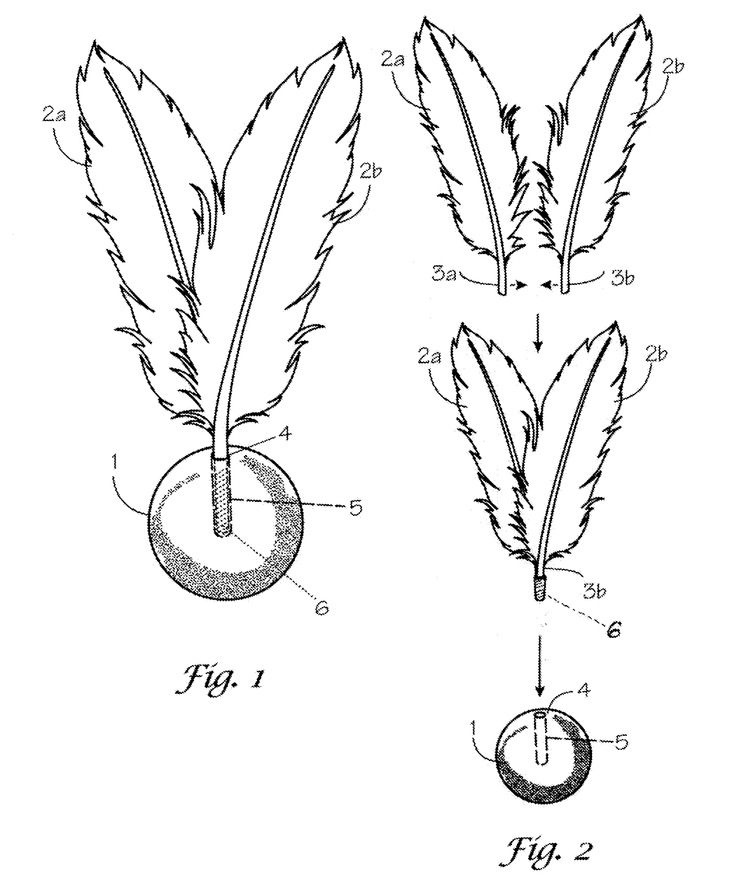

Referring now to the drawings, wherein referenced characters designate like or corresponding parts throughout the several views, there is shown in FIG. 1, an exemplary embodiment of the pet toy. Within FIG. 1, the ball 1 is made of rubber and has a diameter ranging from 24 millimeters (mm) to 32 mm. Balls with diameters less than 24 mm can result in a choking hazard for pets. Field tests also indicate pets, especially kittens, can be intimidated by balls with a diameter that exceeds 32 mm and are often unwilling to play with them. In the preferred embodiment, two natural rooster feathers 2A and 2B are attached to the ball 1. As shown in FIG. 1, the two feathers are approximately of matching size. In the preferred embodiment, the two feathers 2A and 2B protract from the ball 1 between 2 inches and 6 inches in length. Field tests indicate that pets can be intimated by longer feathers. Further, feathers of greater lengths can adversely impact the functionality of the pet toy due to improper mass ratios, decreases in rigidity, and reducing the COR of the pet toy below the acceptable range. Feathers of smaller lengths do not capture the attention of the pets as well as the preferred lengths specified herein.

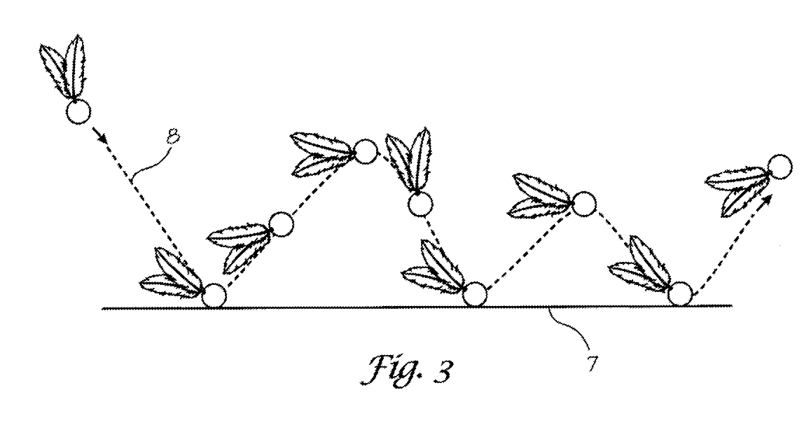

FIG. 2 illustrates steps for the assembly of the pet toy. The hole 4 and the aperture 5 are formed by drilling into the ball 1 using an approximately 7/64-inch drill bit and a standard drill. The aperture 5 depth is approximately half of the diameter of the ball 1. Referring to FIGS. 1 AND 2, two quills 3A and 3B will be fixed to the ball 1 within the aperture 5. Still referring now to FIGS. 1 AND 2, the two feathers 2A and 2B are brought together. As shown in FIG. 2, the two quills 3A and 3B are approximately ½ inch in length and are coated with an adhesive 6 and pressed firmly through the hole 4 into the aperture 5. The two quills 3A and 3B are inserted within the aperture 5 so that a minimal quill length is exposed above the hole 4 as shown in FIG. 1. This configuration allows for the greatest adhesion of the two feathers 2A and 2B with the ball 1. Immediately following the insertion of the two quills 3A and 3B, the adhesive 6 can then be added directly within the aperture 5 to displace any remaining air within the aperture 5. Once cured for a satisfactory period, the adhesive 6 permanently fixes the two quills 3A and 3B and the corresponding two feathers 2A and 2B within the aperture 5 and to the ball 1, respectively.

Referring to FIG. 3, when in operation, the pet toy is bounced against a hard surface 7. Due to the mass differential of the ball 1 and the feathers 2A and 2B, the ball 1 will predominantly make contact with the hard surface 7 before the feathers 2A and 2B until the pet toy approaches a rest position. This ensures constant motion of the pet toy until the energy of the toss dissipates. The trajectory 8 of the pet toy can vary depending on a pet owner's toss. Further, by varying the trajectory 8, speed and spin, the pet owner can change the type of exercise for his pet and provide a new play experience each time the pet toy is used.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying inventive principles.

For example, a version of the pet toy could be developed using other methods to fasten the feathers 2A and 2B to the ball 1. One example of an alternate fastening means could include using an appropriately sized umbrella anchor to hold the quills 3A and 3B and feathers 2A and 2B together before insertion into the aperture 5. The umbrella anchor in addition to the adhesive 6 may be preferred if adhesion failures are a concern. In addition to the fastening means being positioned within the body of the ball 1, a fastener situated on the exterior of the ball 1 could allow for interchangeable attractants. For instance, the feathers 2A and 2B might be replaced with another attractant more preferable to a pet or different color feather combinations could be considered. Although two feathers 2A and 2B are shown in the preferred embodiments, a greater number of feathers could be used if greater plumage is desired and other performance characteristics are maintained.

In the preferred embodiments, the pet toy maintains a high COR. Table One and Table Two illustrate the results of various testing performed to determine the preferred COR value functional range of the pet toy. Testing was conducted in a controlled environment at a constant temperature by dropping test objects from a consistent height of ten (10) feet and measuring the apex of the rebound from a hard surface. Multiple drops and measurements were taken to ensure replicability.

Table One illustrates test results for the COR value ranges for the pet toy, the ball 1, and a standard shuttlecock that is commercially available in the marketplace. The shuttlecock tested for comparison was McGregor Tournament Shuttlecock, McGregor Sporting Goods Inc., New Jersey, United States. The results of the first test are provided in column one. Testing in the first test shows the pet toy has a COR that ranges between 0.77 and 0.85. Column two provides the test results for the ball 1 alone. In this test, all COR values exceed 0.8 and approach 0.9. This high COR for the ball 1 component is critical to the performance, erratic movement, and extended play offered by the pet toy. As expected, due to increasing mass and drag with the inclusion of the two feathers 2A and 2B, the COR for the pet toy is about seven percent less than the COR value for the ball 1 alone. This decrease is acceptable as the two feathers 2A and 2B have been noted as being essential visual attractants and change the center of gravity of the pet toy to assist in its erratic movement. Finally, column three shows the results of the shuttlecock testing. When tested under the same conditions as the pet toy, the McGregor Tournament Shuttlecock has a COR that ranges between 0.30 and 0.33. From a ten-foot drop, the shuttlecock rebound is only about one-foot as compared to the pet toy which rebounded to a height of six to seven feet under the same conditions. Although the shuttlecock has some of the similar features as the pet toy, its narrow and low COR range, necessary for predictable competitive game play, and which results from the material composition of the shuttlecock, does not allow it to perform at a level that attracts and maintains the attention of a pet.

TABLE ONE

| Drop # | Pet Toy | Ball (1) | Shuttlecock |
|---|---|---|---|
| 1 | 0.79 | 0.82 | 0.32 |
| 2 | 0.81 | 0.85 | 0.32 |
| 3 | 0.83 | 0.88 | 0.32 |
| 4 | 0.77 | 0.89 | 0.32 |
| 5 | 0.81 | 0.88 | 0.32 |
| 6 | 0.80 | 0.89 | 0.33 |
| 7 | 0.85 | 0.88 | 0.33 |
| 8 | 0.80 | 0.88 | 0.33 |
| 9 | 0.81 | 0.85 | 0.30 |
| 10 | 0.80 | 0.85 | 0.33 |

In addition to comparison testing with a standard shuttlecock, test comparisons were also performed against other commercially available pet toys in the marketplace. Table Two illustrates test results for the COR value ranges for testing where the pet toy was tested and compared to commercially available pet toys including the Dezi & Roo Wiggly Ball from Dezi & Roo, Marietta, Ga. (Wiggly Ball) and the JW Pet Cataction Featherlite Catnip Boa Bouncing Cat Toy from JW Pet Company, Inc., Teterboro, N.J. (Catnip Boa). In column one, the COR values derived for the pet toy are again tabulated. In this round of testing, as shown in column one, the COR for the pet toy ranged between 0.74 and 0.81. Column two provides the measured COR values for the Dezi & Roo Wiggly Ball which ranged between 0.58 and 0.63. Finally, column three provides the measured COR values for the JW Pet Cataction Featherlite Catnip Boa Bouncing Cat Toy which ranged from 0.26 to 0.39. For further comparison purposes, throughout testing, the preferred embodiments of the pet toy which is the subject of this application had rebound heights between six (6) and seven (7) feet when dropped from rest at ten (10) feet, whereas the Wiggly Ball rebound was not recorded to exceed four (4) feet. The much higher COR value of the pet toy also provides for extended bounce periods when compared to other commercially available pet toys. This extended period results in greater entertainment and exercise for the pet using the pet toy over other commercially available products.

TABLE TWO

| Drop # | Pet Toy | Wiggly Ball | Catnip Boa |
|---|---|---|---|
| 1 | 0.77 | 0.58 | 0.36 |
| 2 | 0.74 | 0.62 | 0.28 |
| 3 | 0.75 | 0.63 | 0.30 |
| 4 | 0.79 | 0.60 | 0.28 |
| 5 | 0.76 | 0.61 | 0.30 |
| 6 | 0.78 | 0.63 | 0.30 |
| 7 | 0.81 | 0.63 | 0.28 |
| 8 | 0.79 | 0.62 | 0.26 |
| 9 | 0.76 | 0.57 | 0.37 |
| 10 | 0.75 | 0.63 | 0.39 |

From the foregoing, it is believed that those skilled in the art will recognize the merits of the advancement and the criticality of the high COR to the pet toy's performance. In addition to the physical adjustments that can vary within the pet toy without compromising the spirit of the invention, considering FIG. 3, the trajectory 8 of the pet toy bounce can also take any number of directions other than the illustrated path. Therefore, considering these and other various examples, the spirit and scope of the appended claims should not be limited to the description of the preferred versions described herein.

What is claimed is:

1. A pet toy, comprising:
a ball; and
at least one feather containing at least one quill that is anchored to the ball;
wherein the pet toy has a coefficient of restitution between 0.74 and 0.85.

2. The pet toy of claim 1, wherein
the ball is composed of a solid elastomeric material;
the ball has a ball diameter between 24 millimeters and 32 millimeters; and
the feathers are between 2 inches and 6 inches long.

3. A pet toy, comprising:
a ball with a center of gravity;
a mass anchored to the ball,
wherein the mass changes the center of gravity of the ball; and
the mass is a visual attractant;
wherein the pet toy has a coefficient of restitution between 0.74 and 0.85.

4. The pet toy of claim 3, wherein the mass comprises at least one feather.
